(19) United States
(12) Patent Application Publication
(10) Pub. No.: US 2026/0320846 A1
(43) Pub. Date: Oct. 15, 2026

(54) ANISOTROPY CODING FOR RENDERING PRIMITIVES

(71) Applicant: Nokia Technologies Oy, Espoo (FI)

(72) Inventors: Daniele MARI, Antwerp (BE); Patrice RONDAO ALFACE, Antwerp (BE)

(21) Appl. No.: 19/633,282

(22) Filed: Mar. 30, 2026

Related U.S. Application Data
(60) Provisional application No. 63/786,582, filed on Apr. 10, 2025.

(51) Int. Cl. G06T 9/00; G06T 9/40

(52) U.S. Cl. CPC G06T 9/001; G06T 9/40

(57) ABSTRACT

An apparatus comprising a processor and a memory storing instructions that, when executed with the processor, cause the apparatus to perform: (i) receiving an input model, the input model comprising a plurality of rendering primitives, (ii) selecting a first codec and a second codec for encoding one or more attributes associated with the plurality of rendering primitives; (iii) encoding, using a first codec, at least one first attribute of at least one of the plurality of rendering primitives, (iv) encoding, using a second codec, at least one second attribute of the at least one of the plurality of rendering primitives, and (v) forming at least one bitstream comprising the at least one first attribute and the at least one second attribute of the at least one of the plurality of rendering primitives. Decoding of the at least one bitstream is performed using the first and second codec by another apparatus.

### TECHNICAL FIELD

The example and non-limiting embodiments relate generally to volumetric frame rendering and, more particularly, to hybrid coding of attributes of rendering primitives of a volumetric frame rendering.

### BRIEF DESCRIPTION OF PRIOR DEVELOPMENTS

There are many ways to capture and represent a volumetric scene. The format used to capture and represent a volumetric scene depends on the processing to be performed on it, and the target application using it.

A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors)

A volumetric frame can be represented as images, with or without depth, captured from multiple viewpoints in 3D space. In other words, the volumetric frame can be represented by one or more view frames where a view is a projection of a volumetric scene on to a plane (the camera plane) using a real or virtual camera with known/computed extrinsic and intrinsic values. Each view may be represented by a number of components (e.g. geometry, color, transparency, and occupancy picture), which may be part of the geometry picture or represented separately.

A volumetric frame can be represented as a mesh. Mesh is a collection of points, called vertices, and connectivity information between vertices, called edges. Vertices along with edges form faces. The combination of vertices, edges and faces can uniquely approximate shapes of objects.

A volumetric frame can be represented as a radiance field, i.e., a representation of rays of light in the scene (sometimes referred to as the plenoptic function or light fields etc.), that can be captured for example by multiple viewpoints such as provided by a number of light field cameras or a number of omnidirectional or plenoptic cameras. Several radiance field representations are described in the following.

A volumetric frame can be represented as an implicit and learned neural radiance field such as the Neural Radiance Field (NeRF) representation for example. A NeRF is a representation of a 3D scene that is parameterized by a deep neural network (DNN). The network predicts a volume density and view-dependent emitted radiance given the spatial location (x, y, z) and viewing direction, e.g., in Euler angles (θ, φ, ψ) of the camera. Volume rendering techniques can produce an image by sampling points along rays intercepted by the camera projection model.

A volumetric frame can be represented as a learned radiance field such as the Gaussian Splatting (a.k.a., 3DGS, 4DGS, Gaussian Splat) representation. This representation can be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame can provide viewers the ability to navigate a scene with six degrees of freedom, i.e., both translational and rotational movement of their viewing pose (which includes yaw, pitch and roll). The data to be coded for a volumetric frame can also be significant, as a volumetric frame can contain large numbers of objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression.

### SUMMARY OF THE INVENTION

The following summary is merely intended to be an example. The summary is not intended to limit the scope of the claims.

In accordance with one aspect, an apparatus is provided comprising: at least one processor; and at least one memory storing instructions that, when executed with the at least one processor, cause the apparatus to perform: a processor and a memory storing instructions that, when executed with the processor, cause the apparatus to perform: (i) receiving an input model, the input model comprising a plurality of rendering primitives, (ii) selecting a first codec and a second codec for encoding one or more attributes associated with the plurality of rendering primitives; (iii) encoding, using the first codec, at least one first attribute of at least one of the plurality of rendering primitives, (iv) encoding, using the second codec, at least one second attribute of the at least one of the plurality of rendering primitives, and (v) forming at least one bitstream comprising the at least one first attribute and the at least one second attribute of the at least one of the plurality of rendering primitives.

In accordance with another aspect, an apparatus is provided comprising: at least one processor; and at least one memory storing instructions that, when executed with the at least one processor, cause the apparatus to perform: a processor and a memory storing instructions that, when executed with the processor, cause the apparatus to perform: (i) receiving at least one bitstream, the at least one bitstream comprising a plurality of rendering primitives and metadata associated with the plurality of rendering primitives, (ii) decoding, using a first codec, at least one first attribute of at least one of the plurality of rendering primitives based at least in part on the metadata associated with the plurality of rendering primitives, (iii) decoding, using a second codec, at least one second attribute of the at least one of the plurality of rendering primitives based at least in part on the metadata associated with the plurality of rendering primitives, and (iv) determining an output of the at least one of the plurality of rendering primitives based at least in part on the at least one first attribute and the at least one second attribute.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 illustrates an example point cloud (e.g., a Gaussian Splat) in accordance with example embodiments of the disclosure;

FIGS. 3A and 3B illustrate example spherical harmonics (FIG. 3A) and a visual comparison with DCT basis functions (FIG. 3B) in accordance with example embodiments of the disclosure;

FIGS. 4A-4D illustrate example image frame packing in accordance with example embodiments of the disclosure;

FIG. 5 illustrates an example image frame packing scheme in accordance with example embodiments of the disclosure;

FIG. 6 illustrates an example image frame unpacking scheme in accordance with example embodiments of the disclosure;

FIG. 7 illustrates an example image frame packing scheme in accordance with example embodiments of the disclosure;

FIG. 8 illustrates an example image frame unpacking scheme in accordance with example embodiments of the disclosure;

FIGS. 9A-9E illustrate example encoder flowcharts in accordance with example embodiments of the disclosure;

FIGS. 10A-10C illustrate example decoder flowcharts in accordance with example embodiments of the disclosure; and

FIGS. 11 and 12 illustrate example flow diagrams in accordance with one or more example embodiments of the disclosure.

### DETAILED DESCRIPTION

The following abbreviations that may be found in the specification and/or the drawing figures are defined as follows:

| | |
|---|---|
| 1D | One Dimensional |
| 2D | Two Dimensional |
| 3D | Three Dimensional |
| DCT | Discrete Cosine Transform |
| G-PCC | ISO/IEC 23090-9 Geometry based |
| | Point Cloud Compression |
| GS | Gaussian Splat |
| KL divergence | Kullback-Leibler divergence |
| LOD | Level of Detail |
| LUT | Look Up Table |
| RAHT | Region-Adaptive Hierarchical Transform |
| SEI | Supplemental Enhancement Information |

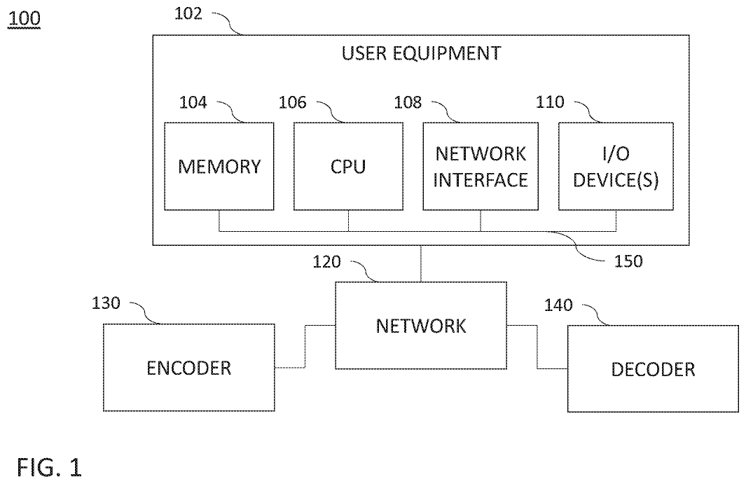

Turning to FIG. 1, this figure shows a block diagram 100 of one possible and non-limiting example in which the examples may be practiced. A user equipment (UE) 102, an encoder device 130, a decoder device 140, and a network 120 are illustrated. Examples of network equipment, network device, or a network entity might be understood to include, at least part of, a transmission reception point or a cell or a gNB or node for example. In the example of FIG. 1, the user equipment (UE) 102 may be in wireless communication with a wireless network 120. A UE may be a wireless device that can access the wireless network 100. The UE 102 includes one or more processors 106, one or more memories 104, one or more network interfaces 108, and one or more input/output device interfaces 110 interconnected through one or more buses 150. Each of the one or more network interfaces 108 may include a receiver, Rx, and a transmitter, Tx. The one or more buses 150 may be address, data, or control buses, and may include any interconnection mechanism, such as a series of lines on a motherboard or integrated circuit, fiber optics or other optical communication equipment, or the like. The one or more network interfaces 108 may be connected to one or more antennas. The one or more memories 104 may include computer program code. The UE 102 may include one or more modules. The modules 140 may be implemented in hardware, such as being implemented as part of the one or more processors 106. The module may be implemented also as an integrated circuit or through other hardware such as a programmable gate array. In another example, the module may be implemented as computer program code and may be executed by the one or more processors 106. For instance, the one or more memories 104 and the computer program code may be configured to, with the one or more processors 106, cause the user equipment 102 to perform one or more of the operations as described herein. The UE 102 may communicate with other user equipment (e.g., additional instantiations of UE 102) via wired or wireless network 120. Encoder 130 or Decoder 140 may include some, all, or additional features described in conjunction with UE 102. For example, Encoder 130 or Decoder 140 may be example instantiations of UE 102. In some embodiments, a UE 102 may have encoding and decoding capabilities as described herein.

The network 120 may include a network element or elements that may include core network functionality, and which provides connectivity via a link or links with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s), and note that both 5G and LTE functions might be supported.

The network 120 may be a wireless network configured to implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors and memories, and also such virtualized entities create technical effects.

The computer readable memories 104 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 104 may be means for performing storage functions. The processors 106 may be of any type suitable to the local technical environment, and may include one or more of general purpose computers, special purpose computers, microprocessors, digital signal processors (DSPs) and processors based on a multi-core processor architecture, as non-limiting examples. The processors 106 may be means for performing functions, such as controlling the UE 102, encoder device 130, decoder device 140, and other functions as described herein.

In general, the various embodiments of the user equipment 102 may include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

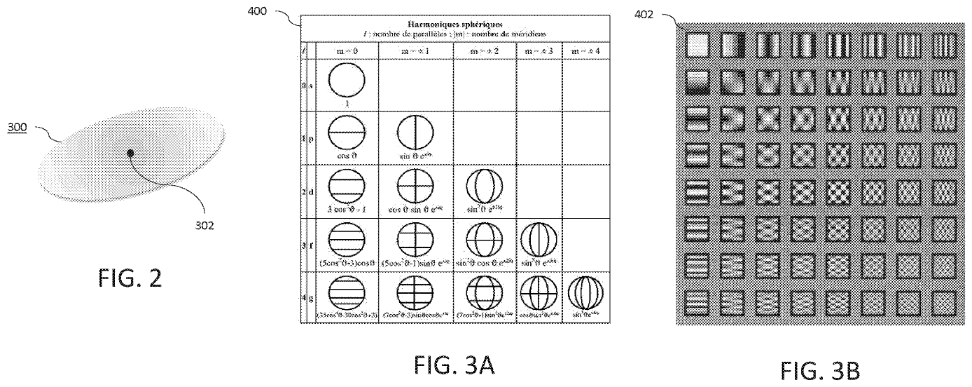

Gaussian splats may be seen as point clouds with additional attributes as illustrated in FIG. 2.
Attributes of the Gaussian Splats include:
   Position (x,y,z)
   Scale (sx,sy,sz); i.e., non-uniform scale factor of the Gaussian splat
   Rotation (rx,ry,rz) or (qx,qy,qz,qw); i.e., the rotation of the Gaussian splat with respect to world coordinates, the rotation is expressed by Euler angles or quaternions
Optionally, Normal (nx, ny, nz); i.e., the normal vector of the Gaussian splat
   Opacity (alpha), i.e., a factor that indicates the transparency of the Gaussian splat
   Color (r,g,b), i.e., the primary color of the Gaussian splat
Spherical harmonics (e.g. SH[0:48]), i.e., the reflectance of the Gaussian splat expressed in spherical harmonics

In some embodiments, color is represented by the DC component of spherical harmonics, and spherical harmonics contain 45 non-DC components. Spherical harmonics can be seen as DCT basis functions defined on the sphere (see FIG. 3).

The rendering function for a Gaussian splat is as follows:

$${g}_{i} ( p ) = αexp ( - \frac{1}{2} ( p - {μ}_{i} ) {\sum }_{i}^{- 1} ( p - {μ}_{i} ) )$$

Where Σ is the covariance matrix and is equal to:

Σ=RSS^{T}R^{T}

Where R is a 3×3 rotation matrix expressed with 4 quaternions and S is a diagonal scaling matrix with 3 parameters for scale.

FIG. 2 illustrates an example Gaussian Splat 200. The position information is the one of its center highlighted by a circle 202. The size and orientation of the shape of splat 200 may be determined by, for example, scale and rotation. The color, transparency and reflectivity may be defined by the spherical harmonics and opacity.

FIG. 3A illustrates example Spherical Harmonics 300. FIG. 3B illustrates a visual comparison with DCT basis functions in 302. Similarly to DCT that enables low to high frequency variations on the horizontal and vertical axis of an image, increasing order of spherical harmonics shows increasing frequency variations in vertical and horizontal directions on the sphere. The first component (m=0, l=0), referred to as DC represents a constant value over the sphere, the second component (m=0, l=1) enables a variation from south pole to north pole following cos (theta), the third component enables a variation from one side of the equator to the other side, etc. Multiplying the three color components RGB to these 15 basis functions on the sphere leads to 45 spherical harmonics components as illustrated in FIGS. 3A and 3B. Some approaches achieve a fast estimation of the Spherical harmonics transform and inverse transform by relying on the FFT.

Other variants of radiance fields representations may include:
Spherical point clouds, which are similar to Gaussian splats except that the shape is spherical, i.e., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats but the rendering equation is defined on a rectangle
2DGS or surfels, similar to Gaussian splats but where the smallest scale is set to zero and a normal is defined. These are typically defined on surfaces in the tangent space. The rendering equation is the same as for Gaussian splats
Gaussian splats with neural appearance attributes, where view dependent appearance is represented by latent variables. The rendering equation requires a MLP to decode the latent appearance

Some variants of Gaussian splats do not explicitly encode a unique center position with extra attributes, but do not prevent from coding or deriving such center position. For example, billboards of Gaussian Textures describe a rectangular tile on which the Gaussian splat representation is defined instead of a single central point. Another example is 3D Convex Splatting (3DCS) that encode a polygonal shape containing N points without encoding any central position. Nevertheless, the appearance attributes are similar to 3DGS as well as the rendering and learning strategy used to model those from input camera views.

Gaussian splats may be coded using different formats. An example of a coding format that is available for Gaussian splat coding is a .spz file format for static Gaussian splats. The .spz file format is a gzipped stream of data consisting of a 16-byte header followed by the gaussian data. This data may be organized by attribute in the following order: positions, scales, rotations, alphas, colors, and spherical harmonics.

In some cases, the header may be as follows in Table I in little-endian.

TABLE I

| PackedGaussianHeader ( ) | |
|---|---|
| uint32_t | magic; |
| uint32_t | version; |
| uint32_t | numPoints; |
| uint8_t | shDegree; |
| uint8_t | fractionalBits; |
| uint8_t | flags; |
| uint8_t | reserved; |

Values may, in one example, be specified as follows:
magic: 0x5053474e
version: 2
numPoints: number of encoded gaussians
shDegree: The degree of spherical harmonics. This must be between 0 and 3 (inclusive).
fractionalBits: number of bits used to store the fractional part of coordinates in the fixed-point encoding.
flags: bit field containing flags.
   0x1: whether the splat was trained with antialiasing.
reserved: Reserved for future use. Must be 0.

In some embodiments, positions may be represented as (x, y, z) coordinates, each as a 24-bit fixed point signed integer. The number of fractional bits may be determined by the fractionalBits field in the header. In some embodiments, scales may be represented as (x, y, z) components, each represented as an 8-bit log-encoded integer. Additionally, rotations may be represented as the (x, y, z) components of the normalized rotation quaternion. Further, the w component may be derived from the others and is not stored. Each component may be encoded as an 8-bit signed integer. In some cases, alphas may be represented as 8-bit unsigned integers. Further, colors may be stored as (r, g, b) values, where each color component is represented as an unsigned 8-bit integer.

In some embodiments, depending on the degree of spherical harmonics for the splat, this can contain 0 (for degree 0), 9 (for degree 1), 24 (for degree 2), or 45 (for degree 3) coefficients per Gaussian. Additionally, the coefficients for a gaussian may be organized such that the color channel is the inner (faster varying) axis, and the coefficient is the outer (slower varying) axis, i.e. for degree 1, the order of the 9 values is:
sh1n1_r, sh1n1 g, sh1n1_b, sh10_r, sh10_g, sh10_b, sh1p1_r, sh1p1_g, sh1p1_b

Each coefficient may be represented as an 8-bit signed integer. Further, additional quantization may be performed to attain a higher compression ratio. This library may, for example, use five bits of precision for degree 0 and four bits of precision for degrees 1 and 2.

In some embodiments, G-PCC may be used to encode arbitrary attributes. An extension of G-PCC requires a simple modification to code quaternions and add the required metadata for pre- and post-processing attributes.

The following example notations may be used for current extension of G-PCC for Gaussian Splats in accordance with the disclosed embodiments:
geometry: xyz positions of points
sh0: DC values of the spherical harmonics
sh1: first 3 AC values of the spherical harmonics
sh2: next 5 AC values of the spherical harmonics
sh3: last 7 AC values of the spherical harmonics
opacity: opacity
scale: scale
rotation: rotation

Table II illustrates an example G-PCC extension bit allocation per component or attribute for a single primitive.

TABLE II

| Component | # of bits | |
|---|---|---|
| Geometry | 3 × 18 | bits |
| sh0 | 3 × 12 | bits |
| sh1 | 3 × 12 | bits |
| sh2 | 5 × 12 | bits |
| sh3 | 7 × 0 | bits |
| opacity | 1 × 12 | bits |
| scale | 3 × 12 | bits |
| rotation | 4 × 12 | bits |
| Total: | 282 | bits |

In some embodiments, a pre-processing step may be performed to quantize components with specific bit depths that are reported in Table 1. G-PCC may be used to encode positions as point clouds and the additional Gaussian splat attributes may, for example, be encoded with (Region-Adaptive Hierarchical Transform) RAHT.

With respect to bitstream signaling in embodiments disclosed herein, similar terminology for encoding syntax as ISOIEC 23090-5 may be used. For example, u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with the most significant bit written first. When n is equal to 0, the associated syntax element is not present in the bitstream and its corresponding value shall be inferred to be equal to 0 unless specified otherwise in the semantics. In another example, ue(v): unsigned integer 0-th order Exp-Golomb-coded syntax element with the left bit first.

For purposes of this disclosure, a “rendering primitive” will refer to Gaussian Splats and their variants. Other terms may be used interchangeably, such as “representative primitive” or “radiance field representation.” Rendering primitives may support anisotropy so that Gaussian splats can stretch and orient themselves differently in space. To do so, rendering primitives may, for example, be parametrized with rotation and scale parameters (e.g., 3D Gaussians, 3D ellipsoids, 3D parallelepiped). In some embodiments, data compression methods are described for encoding various parameters of rendering primitives (e.g., positional data, color, transparency).

In some embodiments, a rendering primitive may be a geometric object that can be used for rendering and it may be characterized by a position in a N-dimensional space. Additionally, a rendering primitive may be characterized by geometric attributes, such as the scales and the rotations for an ellipsoid or a Gaussian, or the dimensions and rotation of a rectangle, cube, plane, hypercube, or the like. Additionally, or alternatively, a rendering primitive may be characterized by additional attributes, such as color, representation learned through gradient descent or a neural network, semantic information, material information, or the like. These types of additional attributes may be referred to as non-geometric or appearance attributes. One example of rendering primitive is a 3D Gaussian splat as described herein.

In the context of image rendering, level-of-detail (LOD) describes a layer in a scalable and hierarchical representation. A LOD is usually linked to resolution scalability, and for the case of point clouds or rendering primitives to different number of primitives, or density of primitives. Accordingly, LOD 0 represents the coarser and sparser representation of an object or scene (useful when viewed from a large distance to optimize primitive to screen pixel usage). LOD 1 is then a refined version of LOD 0 that contains more primitives and forms a denser representation. Typically, LOD i contains N times more primitives than LOD i−1, with for example N being a power of two, but can also be a smaller or larger amount that may not be uniform in all the scene (some parts of the scene may be denser than others due to the content itself).

In some embodiments, a set of rendering primitives may include children and parents rendering primitives. Children and parents rendering primitives may define a hierarchical relationship between rendering primitives where the parent may be obtained by aggregating the information of the children. The parent could be the same or a different type of primitive with reference to the children. Additionally, or alternatively, the parent and children rendering primitives might have different attributes.

A technical effect of the systems and methods described herein include coding rendering primitives, such as Gaussian splats, while providing spatial and temporal random access, as well as spatial and/or quality or complexity scalability.

Prior art approaches rely on octree coding, such as G-PCC extensions described herein and cannot rely on video decoder hardware acceleration for mobile devices or typical platforms having a GPU. While such approaches offer spatial scalability due to the octree structure, they do not support temporal scalability or temporal random access due to the lack of effective motion estimation tools for octrees especially when dealing with sparse data such as Gaussian splats. Octrees may offer some level of random access with constraints that correspond to the octree branches to be decoded for selecting one region. However, in the case of the region to be decoded at the center of the scene, the octree may need to be fully decoded at lower level of detail (LoD) levels.

Other prior art approaches use extensions of V-PCC by generating sparse and large resolution video frames for all attributes (i.e., typically between 11 and 17 frames when not considering spherical harmonics, and up to 59 frames if all SH bands are coded) leading to much larger bitrates and non-efficient video coding. The number of resulting patches is two to three orders of magnitude larger than for dense point clouds and has impacts on metadata bitrate and decoding cost. Moreover, such video-based approaches, while offering temporal random access or scalability based on the video codec and well-chosen encoding settings, they do not offer spatial random access nor spatial scalability as they are currently designed, especially not at the same level as what an octree approach could provide for geometry.

None of the prior approaches offer quality scalability in the sense that one may want to download or decode first the primitive representation format without spherical harmonics, or only a subpart of their bands, for example for a lower complexity decoding and rendering or for rendering parts of a scene or objects that are distant from the viewer's point of view.

The present embodiments may relate to systems and methods for a hybrid coding approach that leverages tree data structures of geometric objects in combination with video coding of part of attribute data associated with the geometric objects. For example, the tree data structure may be an octree-based coding of 3D geometric objects (e.g., a Gaussian splats). Attribute data associated with the geometric objects may include, for example, color, transparency, spherical harmonics, reflectance, or the like.

In some embodiments, a hybrid coding approach that leverages tree data structures of geometric objects in combination with video coding of part of attribute data and coding of coefficients associated with the geometric objects. For example, the tree data structure may be an octree-based coding of 3D geometric objects (e.g., a Gaussian splats). Attribute data associated with the geometric objects may include, for example, color, transparency, spherical harmonics, reflectance, or the like. Coding of coefficients may include, for example, video coding, transform-based attribute coding, or dictionary-based coding. Coefficients associated with the geometric objects may be obtained from attribute data that remain after a dimensionality reduction process is performed. For example, a dimensionality reduction process may be performed to reduce the number of required attribute frames.

In some embodiments, a hybrid coding approach is provided that includes a geometry coding algorithm to pack attribute data associated with rendering primitives into video frames. For example, instead of a projection that leads to sparse frames, a space filling curve is implemented to order rendering primitives (e.g., Gaussian splats) hierarchically to preserve local neighborhoods. This approach provides denser video frames upon rendering. Additionally, this approach may lead to smoother neighborhoods that may be better coded by video codecs when compared to sparsely-filled frames.

In some embodiments, the disclosed methods provides quality scalability. The disclosed methods enables several quality or complexity operating points including (i) geometry decoding at a given level of detail (LOD), (ii) geometry decoding at a given LOD and corresponding color and transparency decoding, and (iii) geometry decoding at a given LOD, corresponding color and transparency attribute values decoding, and spherical harmonics or other reflectance attribute values decoding at a given set of frequency bands.

In some embodiments, the hybrid coding of geometry information methods described herein may be leveraged to code and predict color and transparency attribute values of rendering primitives. Similarly, geometry and color/transparency information may be useful to code spherical harmonic values of rendering primitives. Additionally, or alternatively, the hybrid coding of geometry information methods described herein may be used for image segmentation of a scene into objects or classes. The objects and/or classes may be provided as input or during pre-processing to further improve image packing compression performance of the scene.

In some embodiments, the coding of geometry data consists in coding the primitives positional data using an octree for example based on an octree decomposition. Given the bounding box of the positional data, for example pruned from outlier data in a preprocessing method, an octree may be built with a given number of layers and positions of the primitives that can be linked to cells of the octree (for example handling border cases of positions falling equally in between two octree nodes or cells). Positions may then be quantized by the octree leaves (finest resolution or level). It should be understood that an octree with N levels provides a precision of N bits per 3D coordinate. Provided that this precision is large enough, the differences between the quantized and non-quantized positions may be negligible and lead to visually lossless results. Typically, octree coding is based on a top down and breadth-first strategy. Cells are encoded if and only if they are occupied or if their children are occupied, this allows a sparse representation of the volume of primitive positions. In this context, a cell is said occupied if it is non-empty, or in other words if a primitive position is linked to that cell. As each cell has 8 child cells in an octree, occupancy can be coded with one byte, i.e., one bit per child cell. Typically, arithmetic coding or context-adaptive arithmetic coding can be used on these bytes of occupancy data. Prediction techniques may be used to improve compression, or use look-up tables to code transitions of parent to child occupancy states. Some more advanced approaches may be used to better predict and code empty and non-empty children based on their ancestors. For example, surface approximation can be used to predict children occupancy based on the level and curvature of the surface for example.

Colors, Rotation, Scale, etc. may be coded with an octree coding approach for example by considering their values as indices in a look up table. Then the same algorithm can be used for coding positions in the octree and attributes, except regarding prediction approaches such as surface approximation that may not make sense for other attributes such as rotations, scales, opacity and color. Better prediction approaches for attributes may rely for example on transforms such as RAHT, prediction transform or the lifting scheme. Attribute coding based on the octree may or may not need the geometry to be first encoded, decoded and the attributes remapped to those decoded positions, this step is often called re-colorization in Computer Graphics.

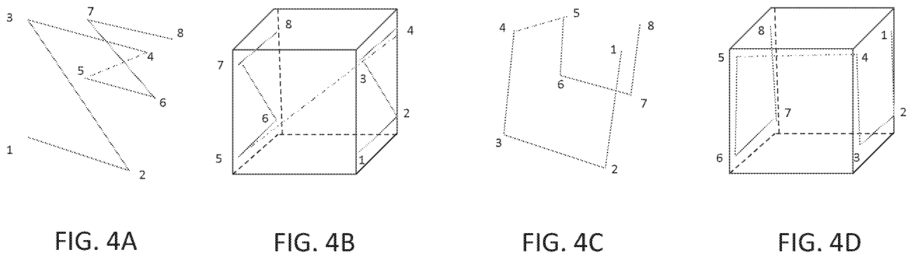

FIGS. 4A-4D illustrate example image frame packing in accordance with example embodiments of the disclosure. In particular, FIGS. 4A and 4B show 3D to 1D scanning with Morton order, which may also be referred to as Z scan. The indices show the traversal order of points in 3D. FIGS. 4C and 4D show an example 3D to 1D scan with a Hilbert space filling curve. Indices represent the order in which points are scanned in 3D.

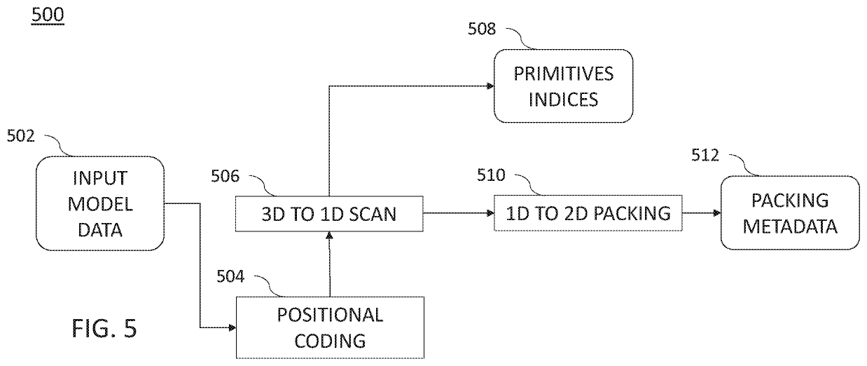

Referring to FIG. 5, an image packing method 500 is illustrated. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. Method 500, at 504, may include encoding positional data of input model data 502. Method 500, at 506, may include 3D to 1D scanning of the positional data to determine primitives indices 508. Scanning may include, for example, a space filling curve such as those represented in FIGS. 4A and 4B for a Morton order or in FIGS. 4C and 4D for a Hilbert space filling curve. Other space filling curves may be used with the goal being to ensure that points that are close to each other in 3D also receive 1D scan indices that are also close to each other. Method 500, at 510, may include 1D to 2D packing of order of primitives or points generated by the 3D to 1D scan to generate packing metadata 512. From the order of primitives or points, an image can be filled using a 1D to 2D packing strategy.

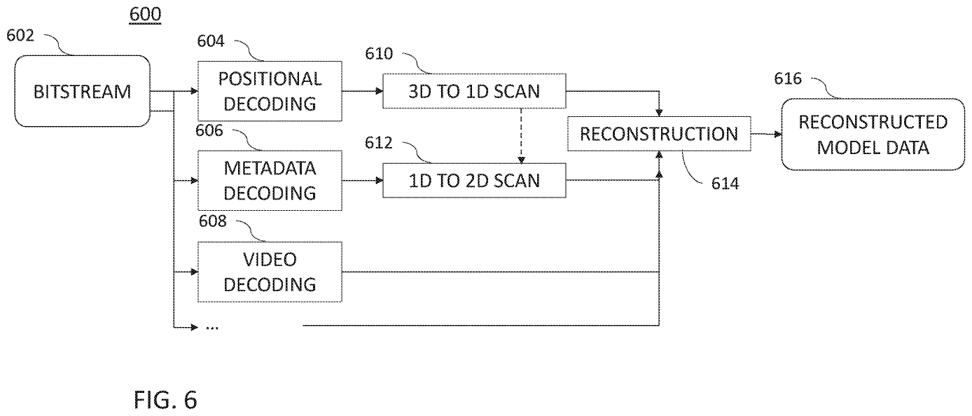

Referring to FIG. 6, an image unpacking method 600 is illustrated. The method may be implemented by a processor of a decoding device. In an example embodiment, the decoding device may be decoder 140 shown in FIG. 1. In some embodiments, decoder 140 may be an instance of user equipment 102 that includes a memory 104, a CPU 106, a network interface 108, and I/O devices 110. Method 600, at 604, may include decoding and extracting positional data from bitstream 602 followed by, at 610, a 3D to 1D scan of the positional data. Method 600, at 606, may include decoding and extracting metadata from bitstream 602 followed by, at 612, a 1D to 2D scan of the output generated by scan 610 and based on metadata signaled by bitstream 602. Method 600, at 608, may include decoding and extracting video data from bitstream 602. Method 600, at 614, may include reconstructing a volumetric representation based on output from 3D to 1D scan 610, 1D to 2D scan 612 and video decoding 608 to generate reconstructed model data 616.

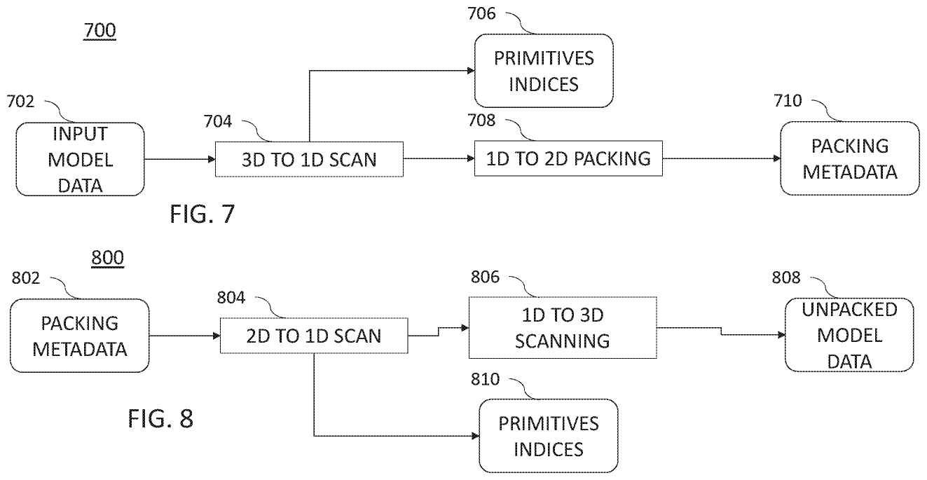

Referring to FIG. 7, an image packing method 700 is illustrated. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. Method 700, at 704, may include 3D to 1D scanning of input model data 702 to generate primitives indices 706. Scanning may include, for example, a space filling curve such as those represented in FIGS. 4A and 4B for a Morton order or in FIGS. 4C and 4D for a Hilbert space filling curve. Other space filling curves may be used with the goal being to ensure that points that are close to each other in 3D also receive 1D scan indices that are also close to each other. Method 700, at 708, may include 1D to 2D packing of order of primitives or points generated by the 3D to 1D scan to generate packing metadata 710. From the order of primitives or points, an image can be filled using a 1D to 2D packing strategy.

Referring to FIG. 8, a metadata unpacking method 800 is illustrated. The method may be implemented by a processor of a decoding device. In an example embodiment, the decoding device may be decoder 140 shown in FIG. 1. In some embodiments, decoder 140 may be an instance of user equipment 102 that includes a memory 104, a CPU 106, a network interface 108, and I/O devices 110. Method 800, at 804, may include 2D to 1D scanning of image packing metadata 802 followed by, at 806, a 1D to 3D scan of results from 2D to 1D scanning to generate unpacked model data 808. Method 800, at 804, may also include generating primitives indices 810 from 2D to 1D scanning of image packing metadata 802.

A 1D to 2D packing strategy may for example also use a Morton order or a Hilbert space filling curve to provide 2D image coordinates to the primitives that were ordered in 1D. The frame size can be initialized such that it is able to contain all primitives, for example width and height are selected as the integers that satisfy (where ceil corresponds to rounding a float number to the closest larger integer value): width=height=Ceil (sqrt (primitive_count))

Primitive_count is the number of primitives of a volumetric frame for static content or for example the maximum number of rendering primitives in each frame of a group of frames of the content, for example a Group of 32 frames. This allows for maintaining the frame size to the same resolution for the full group of frames at the cost of having a number of pixels that are not assigned to a rendering primitive for one or all frames.

In some embodiments, an image or frame may be filled from top left to bottom right sequentially until there are no longer rendering primitives to encode. Additionally, or alternatively, it may be decided to configure at the encoder side the image into tiles that correspond to octants of the scene as described by an octree, so as to provide random access capabilities. In some cases the rendering primitives may be divided into different LoDs (for example by looking at the size of the primitive) and encode different LoDs in different tiles. Further, slices and subpictures may be used depending on the capabilities of the selected video codec.

In some embodiments, rendering primitive distributions may be sparse and many indices in the 3D to 1D scanning may be empty (i.e., the corresponding voxels are not occupied by a rendering primitive). In this scenario, this issue may be addressed by skipping empty voxels and assigning indices to non-empty voxels only. This may cause two issues: 1) It is not possible to convert back the 1D indices to the corresponding 3D coordinates using the inverse of the space filling curve so the 3D coordinates need to be encoded separately (e.g. using an octree based approach as previously described), and 2) Primitives with close 1D indices may be distant from each other, and that their attributes may be significantly different because the primitives represent different objects for example. Then the resulting 1D to 2D mapping will generate an image where pixels are significantly different from their neighborhood leading to non-easily compressible frames, typically leading to one order of magnitude higher compression rates and unacceptable distortions when not using lossless coding.

A naïve approach that only considers the positions of rendering primitives but not their volume or area (volume parameterized by rotation and scale for Gaussian splats for example, or area for billboards parameterized by width and height etc.) will also typically lead to suboptimal packing strategies with pixels being different from their neighborhood. An approach that would not consider occupancy would also lead to very large resolutions of frames, leading to unacceptable resolutions for a decoder, and bitrates for transmission.

In one example embodiment, the scanning does not only search for occupied positions but also considers the volume of primitives. While it is important to keep a single mapping between the 1D order and the presence of a rendering primitive (i.e. one index for one primitive) the volume may be exploited to improve the 2D packing that follows.

In one example embodiment, the volume of primitives may be stored per rendering primitive in number of voxels that it occupies. A block size may be configured by the encoder to map a rendering primitive in the resulting packed frame to a block (for example a 3×3 pixels block) instead of a single pixel. In some embodiments, if the volume of the rendering primitive is smaller than a threshold, then the rendering primitive attribute value is copied only on the central pixel of the block, if that central pixel does not map to an integer position because the block has an even size (e.g. 4×4), then all pixels surrounding this central fraction position will be used for packing the value of the corresponding primitive attribute. If the rendering primitive volume is larger than a threshold, then more pixels (for example all pixels of the block) are used to pack the corresponding primitive attribute value. In case of large blocks such as 5×5, one can think of two thresholds and use 1×1 pixel, 3×3 pixels or 5×5 pixels in the block based on the volume and the two thresholds. Unused pixel values in the frame and inside blocks will be filled with background filling techniques such as those for example used in V3C (push-pull filling, multi-resolution diffusion filling etc.) to create smoother transitions that are easier to code with a video codec. All metadata needed to decode the packed image may be signaled in or along the bitstream.

In another embodiment, the scale value attributes may be encoded/decoded before the other attributes allowing to compute the volume before the other attributes are encoded/decoded.

In another embodiment, a segmentation of the rendering primitives may be obtained either as input or as a result of the pre-processing module. Rendering primitives that share similar attribute values may receive similar or the same segmentation tags. In some cases, the image packing scheme may take this information into account such that it modifies the 3D to 1D scanning, by processing rendering primitives each segmentation tag in order first. That is, the 3D to 1D scanning only processes rendering primitives with a given tag, then restarts the scanning for primitives with a second tag etc. The 1D to 2D packing may also define tiles or slices or other partitions based on the segmentation tag, or not. This approach enables to reduce the dissimilarity between eventually packed pixels because the initial proximity of primitives in 1D or 3D scanning was not linked to a similarity in attributes.

In one embodiment, the N different segmentation tags may be used to generate N different positional coding substreams, i.e., one octree coding per segmentation tag. In another embodiment, one octree positional coding of all primitives may be performed and the rendering primitives' tags are encoded as an attribute to the octree nodes. Using one or the other approach, a decoder may map the scan order per encoded octree or thanks to the attribute coded segmentation tags in the octree.

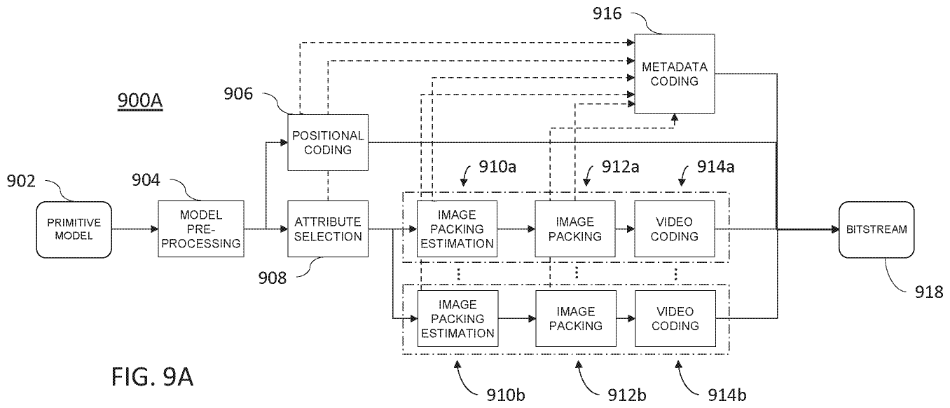

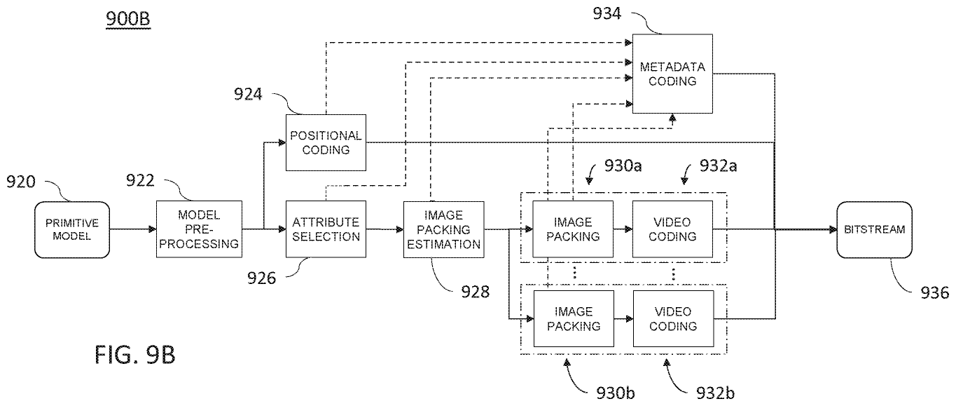

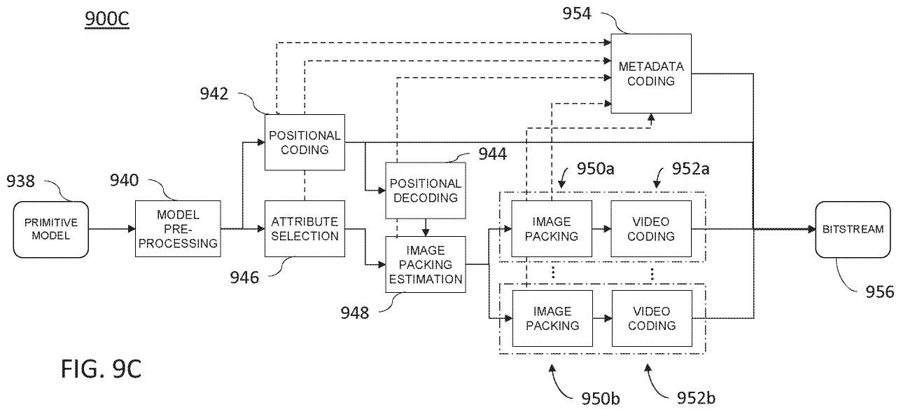

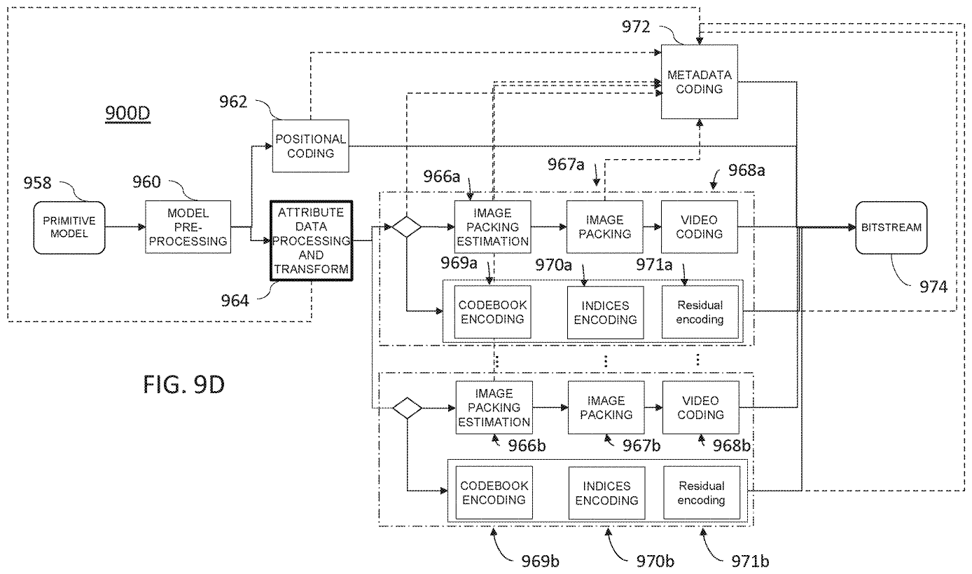

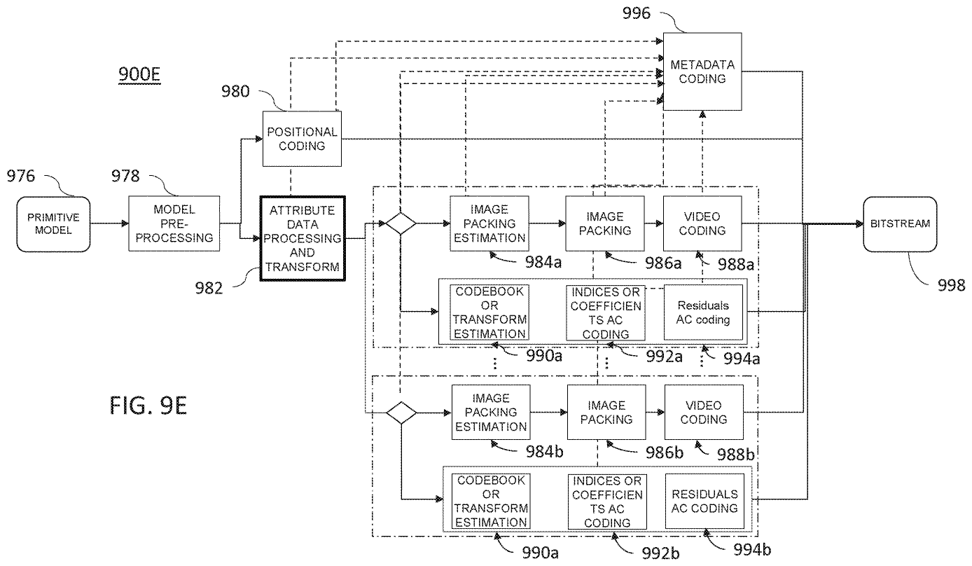

Method 900A of FIG. 9A provides an example encoding process using two codecs in accordance with at least one embodiment. The two codecs in this example include positional coding and video-based encoding. Further, this example method includes image packing estimation that may be made specific for each attribute. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110.

Method 900A, at 904, may include receiving primitive model 902 for model pre-processing. Model pre-processing may include, for example, analyzing and voxelizing primitive model 902 to determine parameters and attribute values associated with one or more rendering primitives of primitive model 902. Parameters and attribute values associated with one or more rendering primitives of primitive model 902 may include positional data, scales, rotations, color, transparency, spherical harmonics, reflectance, or the like.

Method 900A, at 906, may include encoding positional data of one or more rendering primitives of primitive model 902. Encoded positional data may be added to bitstream 918. Metadata pertaining to the positional data may be passed to metadata coding 916. Positional coding 906 may include an octree-based codec. The octree-based codec may be used to encode primitive positional data and image packing.

Method 900A, at 908, may include selecting attributes of the rendering primitives for encoding. Selected attributes may be passed to image packing estimation 910a and/or 910b. Image packing estimation 910a may be performed for a first attribute and image packing estimation 910b may be performed for a second attribute. While only two image packing estimation blocks are shown, it is understood that an image pack subroutine may be instantiated for each attribute selected at 908. Method 900A, at 912a, may include image packing of the first attribute. Image packing may use an octree-based coding scheme. Method 900A, at 914a, may include video encoding of the result generated by image packing 912a. Results of video coding 914a may be added to bitstream 918. Metadata pertaining to the image packing subroutine may be generated and passed to metadata coding 916. Method 900A, at 912b, may include image packing of the second attribute. Image packing may use an octree-based coding scheme. Method 900A, at 914b, may include video encoding of the result generated by image packing 912b. Results of video coding 914b may be added to bitstream 918. Metadata pertaining to the image packing subroutine may be generated and passed to metadata coding 916. This process may be repeated for each additional attribute selected at 908. Method 900A, at 916, may include encoding of all metadata collected. The encoded metadata may be added to bitstream 918.

Method 900B of FIG. 9B provides an example encoding process using two codecs in accordance with at least one embodiment. The two codecs in this example include positional coding and video-based encoding. Further, this example method includes image packing estimation that may be common for all attributes of a set of rendering primitives. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. For example, at 920, method 900B may include receiving as input a primitive model comprising a set of rendering primitives.

Method 900B, at 922, may include receiving primitive model 920 for model pre-processing. Model pre-processing may include, for example, analyzing and voxelizing primitive model 920 to determine parameters and attribute values associated with one or more rendering primitives of primitive model 920. Parameters and attribute values associated with one or more rendering primitives of primitive model 920 may include positional data, scales, rotations, color, transparency, spherical harmonics, reflectance, or the like.

Method 900B, at 924, may include encoding positional data of one or more rendering primitives of primitive model 920. Encoded positional data may be added to bitstream 936. Metadata pertaining to the positional data may be passed to metadata coding 934. Positional coding 924 may include an octree-based codec. The octree-based codec may be used to encode primitive positional data and image packing.

Method 900B, at 926, may include selecting attributes of the rendering primitives for encoding. Selected attributes may be passed to image packing estimation 928. Image packing estimation 926 may be performed for all attributes selected at 926. Results of image packing estimation 928 may be sent for image packing and video coding. Image packing and video coding may be performed for each selected attribute. While only two image packing subroutines are shown, it is understood that an image packing and video coding may be instantiated for each attribute selected at 926. Method 900B, at 930a, may include image packing of a first attribute. Image packing may use an octree-based coding scheme. Method 900B, at 932a, may include video encoding of the result generated by image packing 930a. Results of video coding 932a may be added to bitstream 936. Metadata pertaining to the image packing subroutine may be generated and passed to metadata coding 934. Method 900B, at 930b, may include image packing of a second attribute. Image packing may use an octree-based coding scheme. Method 900B, at 932b, may include video encoding of the result generated by image packing 930b. Results of video coding 932b may be added to bitstream 936. Metadata pertaining to the image packing subroutine may be generated and passed to metadata coding 934. This process may be repeated for each additional attribute selected at 926. Method 900B, at 934, may include encoding of all metadata collected. The encoded metadata may be added to bitstream 936.

Method 900C of FIG. 9C provides an example encoding process using two codecs in accordance with at least one embodiment. The two codecs in this example include positional coding and video-based encoding. In this example, the positional coding and decoding may be performed before image packing estimation. Further, this example method includes image packing estimation that may be common for all attributes of a set of rendering primitives. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. For example, at 938, method 900C may include receiving as input a primitive model comprising a set of rendering primitives.

Method 900C, at 940, may include receiving primitive model 938 for model pre-processing. Model pre-processing may include, for example, analyzing and voxelizing primitive model 938 to determine parameters and attribute values associated with one or more rendering primitives of primitive model 938. Parameters and attribute values associated with one or more rendering primitives of primitive model 938 may include positional data, scales, rotations, color, transparency, spherical harmonics, reflectance, or the like.

Method 900C, at 942, may include encoding positional data of one or more rendering primitives of primitive model 938. Encoded positional data may be added to bitstream 956. Metadata pertaining to the positional data may be passed to metadata coding 954. Positional coding 942 may include an octree-based codec. The octree-based codec may be used to encode primitive positional data and image packing. Method 900C, at 944, may include decoding positional data generated by 942, the results being passed to 948 and used for image packing estimation. This enables a reduction in the amount of rendering primitives that may be merged or discarded as a result of positional quantization.

Method 900C, at 946, may include selecting attributes of the rendering primitives for encoding. Selected attributes may be passed to image packing estimation 948. Image packing estimation 946 may be performed for all attributes selected at 946. Results of image packing estimation 948 may be sent for image packing and video coding. Image packing and video coding may be performed for each selected attribute. While only two image packing subroutines are shown, it is understood that an image packing and video coding may be instantiated for each attribute selected at 946. Method 900C, at 950a, may include image packing of a first attribute. Image packing may use an octree-based coding scheme. Method 900C, at 952a, may include video encoding of the result generated by image packing 950a. Results of video coding 952a may be added to bitstream 956. Metadata pertaining to the image packing subroutine may be generated and passed to metadata coding 954. Method 900C, at 950b, may include image packing of a second attribute. Image packing may use an octree-based coding scheme. Method 900C, at 952b, may include video encoding of the result generated by image packing 950b. Results of video coding 952b may be added to bitstream 956. Metadata pertaining to the image packing subroutine may be generated and passed to metadata coding 954. This process may be repeated for each additional attribute selected at 946. Method 900C, at 954, may include encoding of all metadata collected. The encoded metadata may be added to bitstream 956.

Method 900D of FIG. 9D provides an example encoding process using three or more codecs in accordance with at least one embodiment. The three or more codecs in this example may include positional coding, video-based encoding, transform-based attribute coding, dictionary-based coding, or a combination thereof. Further, this example method includes image packing estimation that may be made specific for each attribute. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. For example, at 958, method 900D may include receiving as input a primitive model comprising a set of rendering primitives.

Method 900D, at 960, may include receiving primitive model 958 for model pre-processing. Model pre-processing may include, for example, analyzing and voxelizing primitive model 958 to determine parameters and attribute values associated with one or more rendering primitives of primitive model 958. Parameters and attribute values associated with one or more rendering primitives of primitive model 958 may include positional data, scales, rotations, color, transparency, spherical harmonics, reflectance, or the like.

Method 900D, at 962, may include encoding positional data of one or more rendering primitives of primitive model 958. Encoded positional data may be added to bitstream 974. Metadata pertaining to the positional data may be passed to metadata coding 972. Positional coding 962 may include an octree-based codec. The octree-based codec may be used to encode primitive positional data and image packing.

Method 900D, at 964, may include processing and transforming attribute data as well as attribute coefficients. Attribute coefficients may be passed to image packing estimation 966a and/or 966b. Image packing estimation 966a may be performed for a first attribute and image packing estimation 966b may be performed for a second attribute. While only two image packing subroutines are shown, it is understood that an image pack subroutine may be instantiated for each attribute coefficient determined at 964. Method 900D, at 967a, may include image packing of the first attribute. Image packing may use an octree-based coding scheme. Method 900D, at 968a, may include video encoding of the result generated by image packing 967a. Results of video coding 968a may be added to bitstream 974. Additionally, method 900D may include codebook encoding 969a, indices encoding 970a, and residual encoding 971a of the attribute coefficient. Residual encoding 971a may be added to bitstream 971a. Metadata pertaining to the image packing subroutine may be generated and passed to metadata coding 972. Method 900D, at 967b, may include image packing of the second attribute coefficient. Image packing may use an octree-based coding scheme. Method 900D, at 968b, may include video encoding of the result generated by image packing 967b. Results of video coding 968b may be added to bitstream 974. Additionally, method 900D may include codebook encoding 969b, indices encoding 970b, and residual encoding 971b of the attribute coefficient. Residual encoding 971b may be added to bitstream 971b. Metadata pertaining to the image packing subroutine may be generated and passed to metadata coding 972. Method 900D, at 972, may include encoding of all metadata collected. The encoded metadata may be added to bitstream 974.

Method 900E of FIG. 9E provides an example encoding process using three or more codecs in accordance with at least one embodiment. The three or more codecs in this example may include positional coding, video-based encoding, transform-based attribute coding, dictionary-based coding. Additionally, this example encoding process may include methods for estimating codebook entries and/or data transformation values for the selected attributes. Further, this example method includes image packing estimation that may be made specific for each attribute. The method may be implemented by a processor of an encoding device. In an example embodiment, the encoding device may be encoder 130 shown in FIG. 1. In some embodiments, encoder 130 may be an instance of user equipment 102 that includes a memory 104, a CPU 106, a network interface 108, and I/O devices 110. For example, at 976, method 900E may include receiving as input a primitive model comprising a set of rendering primitives.

Method 900E, at 978, may include receiving primitive model 976 for model pre-processing. Model pre-processing may include, for example, analyzing and voxelizing primitive model 976 to determine parameters and attribute values associated with one or more rendering primitives of primitive model 976. Parameters and attribute values associated with one or more rendering primitives of primitive model 976 may include positional data, scales, rotations, color, transparency, spherical harmonics, reflectance, or the like.

Method 900E, at 980, may include encoding positional data of one or more rendering primitives of primitive model 976. Encoded positional data may be added to bitstream 998. Metadata pertaining to the positional data may be passed to metadata coding 996. Positional coding 980 may include an octree-based codec. The octree-based codec may be used to encode primitive positional data and image packing.

Method 900E, at 982, may include processing and transforming attribute data as well as attribute coefficients. Attribute coefficients may be passed to image packing estimation 984a and/or 984b. Image packing estimation 984a may be performed for a first attribute and image packing estimation 984b may be performed for a second attribute. While only two image packing subroutines are shown, it is understood that an image pack subroutine may be instantiated for each attribute coefficient determined at 982. Method 900E, at 986a, may include image packing of the first attribute. Image packing may use an octree-based coding scheme. Method 900E, at 988a, may include video encoding of the result generated by image packing 986a. Results of video coding 988a may be added to bitstream 998. Additionally, method 900E may include codebook or transformation estimation 990a, indices or coefficients AC encoding 992a, and residuals AC encoding 994a of the attribute coefficient. Residuals AC encoding 994a may be added to bitstream 994a. Metadata pertaining to the image packing subroutine may be generated and passed to metadata coding 996. Method 900E, at 986b, may include image packing of the second attribute coefficient. Image packing may use an octree-based coding scheme. Method 900E, at 988b, may include video encoding of the result generated by image packing 986b. Results of video coding 988b may be added to bitstream 998. Additionally, method 900E may include codebook or transformation estimation 990b, indices or coefficients AC encoding 992b, and residual encoding 994b of the attribute coefficient. Residual encoding 994b may be added to bitstream 994b. Metadata pertaining to the image packing subroutine may be generated and passed to metadata coding 996. Method 900E, at 996, may include encoding of all metadata collected. The encoded metadata may be added to bitstream 998.

FIGS. 9D and 9E illustrate the use of a third type of codecs for some attributes allowing for example to use, a transform and/or a codebook, coefficient coding or vector quantization, indices and codebook encoding for example. Optionally, residuals may also be encoded. The codec for such advanced approaches could be an AC codec, meaning that coefficients, residuals, and all required information may be encoded using arithmetic coding (for example using CABAC). Spherical Harmonics are one example of attribute data for which dimensionality reduction and vector quantization may be more efficient than creating one image frame per SH component. Similarly, transforms may be used to address SH components redundancy between spatial resolution layers. Such transforms could be RAHT, prediction transform, lifting scheme etc. One alternative to these drawings could also consist in packing the data generated during vector quantization (indices and residuals) into frames and then use a video codec. Variants including common packing estimation for all attributes using video coding, or the use of the positional data decoding also apply to FIGS. 9D and 9E.

Embodiments of encoders for representation primitives include the following methods and systems, a model pre-processing method that analyzes and voxelizes the input model. After pre-processing, an attribute selection method, or an attribute processing and transform method analyzes attribute data and selects, based on heuristics or statistical analysis, which codec is the most suitable for coding this data. This method may be preceded by positional coding and decoding in one embodiment.

For example, the method can select RAHT-based coding for scales and rotations, and image packing and video coding for other attribute data. Finally, for example, the method may select a dimensionality reduction approach such as direct or hierarchical residual K-NN, PCA or others to reduce the dimensionality of the attribute data (for example for Spherical Harmonics).

Metadata may be collected in all methods of the encoder to enable a decoder to reconstruct the primitives. Positional coding method may rely on point cloud coding approaches, for example, octree based such as G-PCC or similar approaches. Image packing estimation methods test different packing strategies based on encoder configuration and data density in 3D space. The Image packing method transforms the attribute data into a frame (using the image packing metadata obtained in the image packing estimation module) that is encoded in the video codec that can use for example H.265/HEVC to compress the frame.

In case Vector Quantization and/or dimensionality reduction is used and available at the encoder, the codebook may be built for one or several frames and embedded in or along the bitstream. The indices of primitives attributes corresponding to the obtained codebook entries may also be coded in the bitstream, with optionally the residual between the codebook prediction and the actual value. In case transform-based coding is selected, then coefficients are encoded and optionally their residuals. Codecs that can handle vector quantization or transform-based coding as AC codecs are referred to because they have in common the use of arithmetic or entropy coding, and because at this stage, there are, except a few exceptions such as G-PCC, no available standards or dedicated codecs for such coding tools.

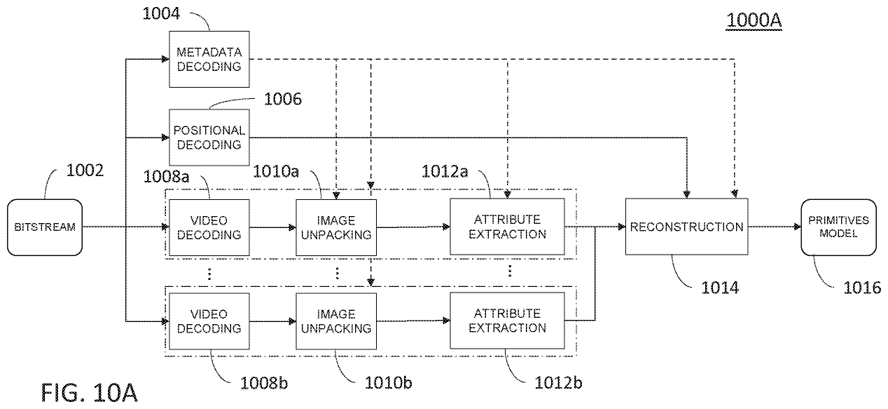

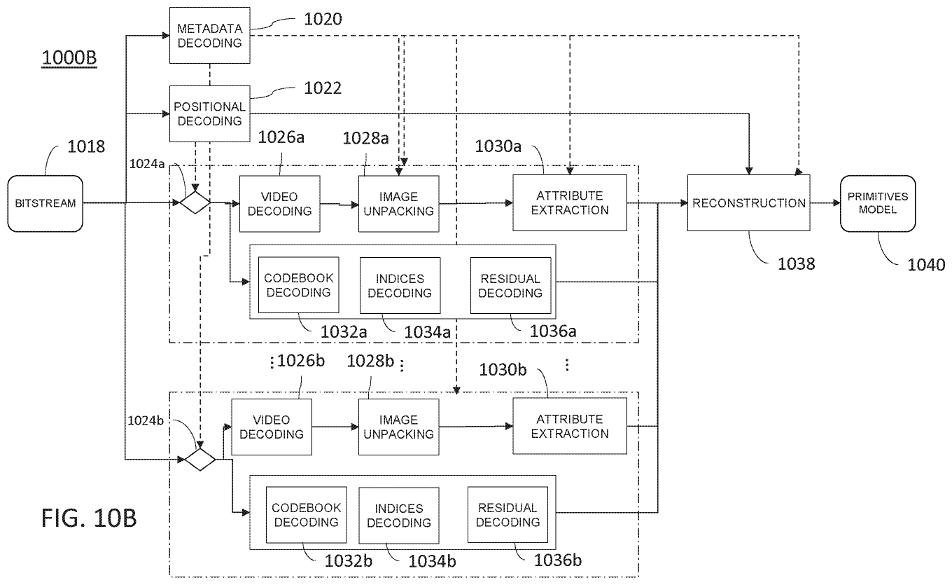

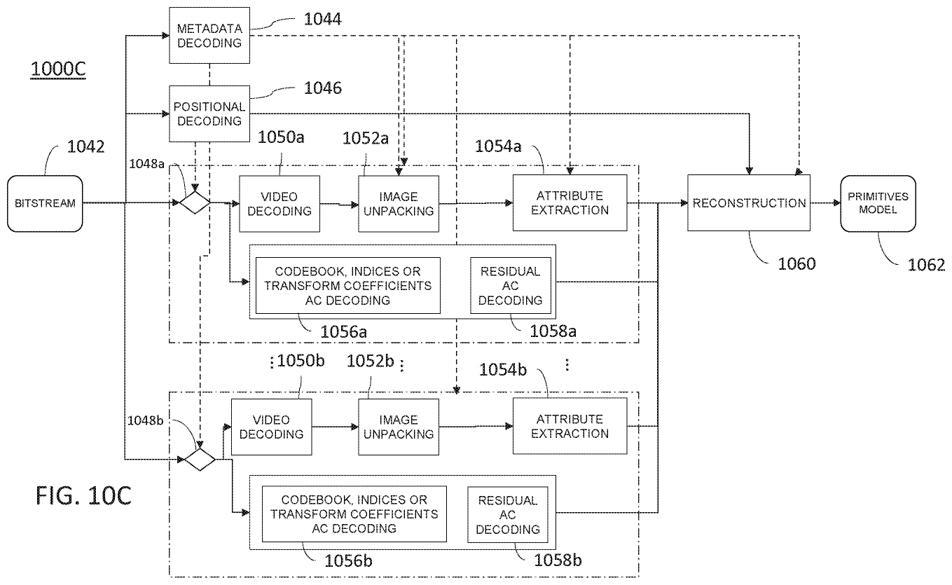

FIGS. 10A-10C illustrate example decoder schemes that correspond to the encoder schemes illustrated in FIGS. 9A-9E. FIG. 10A depicts an example decoder scheme with two codecs. FIG. 10B depicts an example decoder scheme with three or more codecs. FIG. 10C depicts an example decoder scheme that also illustrates an unpacking strategy.

Method 1000A of FIG. 10A provides an example decoding procedure for decoding rendering primitives and their respective attribute values to reconstruct rendering primitives. For example, rendering primitives may be reconstructed to provide a rendering of a volumetric representation of an object. The method may be implemented by a processor of a decoding device. In an example embodiment, the decoding device may be decoder 140 that receives one or more bitstreams from encoder 130 via network 120 shown in FIG. 1. In some embodiments, decoder 140 may be an instance of user equipment 102 that includes a memory 104, a CPU 106, a network interface 108, and I/O devices 110. Method 1000A may include a first video codec 1006 and a second video codec (e.g., 1008a, 1000b).

Method 1000A may include receiving bitstream 1002. Bitstream 1002 may include a single bitstream of data or a plurality of bitstreams of data. Bitstream 1002 may, at least in part, be an encoded bitstream generated by one or more encoding schemes described herein with respect to FIGS. 9A-9E.

Method 1000A, at 1004, may include extracting and decoding metadata from bitstream 1002.

Method 1000A, at 1006, may include decoding and extracting positional data associated with rendering primitives from bitstream 1002. In some embodiments, method 1000A, at 1006, may also include decoding attribute values that are associated with positional data from bitstream 1002. Attribute values associated with positional data may include, for example, one or more image segmentation tags.

Method 1000A, at 1008a, may include decoding and extracting video using a video codec from bitstream 1002. Method 1000A, at 1010a, if image packing is signaled by metadata as determined by 1004, may include image unpacking. Image unpacking 1010a may include 2D to 1D scanning and 1D to 3D scanning as described herein. Method 1000A, at 1012a, may include extracting attribute values from the unpacked image for reconstruction 1014 of rendering primitives. Method 1000A, at 1008b, may include decoding and extracting video using a video codec from bitstream 1002. Method 1000A, at 1010b, if image packing is signaled by metadata as determined by 1004, may include image unpacking. Image unpacking 1010b may include 2D to 1D scanning and 1D to 3D scanning as described herein. Method 1000A, at 1012b, may include extracting attribute values from the unpacked image for reconstruction 1014 of rendering primitives. This process may be repeated for each attribute value provided by bitstream 1002.

Method 1000A may include, at 1014, reconstructing rendering primitives to generate primitives model 1016.

Method 1000B of FIG. 10B provides an example decoding procedure for decoding rendering primitives and their respective attribute values to reconstruct rendering primitives using three or more video codecs. For example, rendering primitives may be reconstructed to provide a rendering of a volumetric representation of an object. The method may be implemented by a processor of a decoding device. In an example embodiment, the decoding device may be decoder 140 that receives a bitstream from encoder 130 via network 120 shown in FIG. 1. In some embodiments, decoder 140 may be an instance of user equipment 102 that includes a memory 104, a CPU 106, a network interface 108, and I/O devices 110. Method 1000B may include a first video codec 1022, a second video codec (e.g., 1026a, 1026b), and a third video codec (e.g., 1032a, 1032b).

Method 1000B may include receiving bitstream 1020. Bitstream 1020 may include a single bitstream of data or a plurality of bitstreams of data. Bitstream 1020 may, at least in part, be an encoded bitstream generated by one or more encoding schemes described herein with respect to FIGS. 9A-9E.

Method 1000B, at 1020, may include extracting and decoding metadata from bitstream 1020.

Method 1000B, at 1022, may include decoding and extracting positional data associated with rendering primitives from bitstream 1020. In some embodiments, method 1000B, at 1022, may also include decoding attribute values that are associated with positional data from bitstream 1020. Attribute values associated with positional data may include, for example, one or more image segmentation tags.

Method 1000B, at 1024a, may include a decision mechanism to select an attribute for decoding and at what level (e.g., Level of detail). Method 1000B, at 1026a, may include, using the selected video codec, decoding and extracting video using the selected video codec from bitstream 1020. Method 1000B, at 1028a, if image packing is signaled by metadata as determined by 1020, may include image unpacking. Image unpacking 1028a may include 2D to 1D scanning and 1D to 3D scanning as described herein. Method 1000B, at 1030a, may include extracting attribute values from the unpacked image. Extracted attribute values may be passed to reconstruction 1038. Method 1000B, at 1032a, may include codebook decoding. Method 1000B, at 1034a, may include indices decoding. Method 1000B, at 1036a, may include residual decoding. Results generated by 1032a, 1034a and 1036a may be passed to reconstruction 1038.

Method 1000B, at 1024b, may include a decision mechanism to select a video codec for decoding and at what level (e.g., Level of detail). Method 1000B, at 1026b, may include, using the selected video codec, decoding and extracting video using a first codec from bitstream 1020. Method 1000B, at 1028b, if image packing is signaled by metadata as determined by 1020, may include image unpacking. Image unpacking 1028b may include 2D to 1D scanning and 1D to 3D scanning as described herein. Method 1000B, at 1030b, may include extracting attribute values from the unpacked image. Extracted attribute values may be passed to reconstruction 1038. Method 1000B, at 1032b, may include codebook decoding. Method 1000B, at 1034b, may include indices decoding. Method 1000B, at 1036b, may include residual decoding. Results generated by 1032b, 1034b and 1036b may be passed to reconstruction 1038.

In some embodiments, the decoder decodes video substreams containing attribute data and optionally, decodes codebooks, codeword indices and residuals substreams, or transform coefficients for attributes if present. In case of frame packing being signaled in the metadata, the decoder may apply unpacking as signalled by the metadata, which includes 2D to 1D scanning and 1D to 3D scanning. This process may be repeated for each attribute in the bitstream until all attributes have been decoded.

Method 1000B may include, at 1038, reconstructing rendering primitives to generate primitives model 1040.

Method 1000C of FIG. 10C provides an example decoding procedure for decoding rendering primitives and their respective attribute values to reconstruct rendering primitives using three or more video codecs. For example, rendering primitives may be reconstructed to provide a rendering of a volumetric representation of an object. The method may be implemented by a processor of a decoding device. In an example embodiment, the decoding device may be decoder 140 that receives a bitstream from encoder 130 via network 120 shown in FIG. 1. In some embodiments, decoder 140 may be an instance of user equipment 102 that includes a memory 104, a CPU 106, a network interface 108, and I/O devices 110. Method 1000C may include a first video codec (e.g., 1046), a second video codec (e.g., 1050a, 1050b), and a third video codec (e.g., 1056a, 1056b).

Method 1000C may include receiving bitstream 1042. Bitstream 1042 may include a single bitstream of data or a plurality of bitstreams of data. Bitstream 1042 may, at least in part, be an encoded bitstream generated by one or more encoding schemes described herein with respect to FIGS. 9A-9E.

Method 1000C, at 1042, may include extracting and decoding metadata from bitstream 1042.

Method 1000C, at 1044, may include decoding and extracting positional data associated with rendering primitives from bitstream 1042. In some embodiments, method 1000C, at 1044, may also include decoding attribute values that are associated with positional data from bitstream 1042. Attribute values associated with positional data may include, for example, one or more image segmentation tags.

Method 1000C, at 1048a, may include a decision mechanism to select a video codec for decoding and at what level (e.g., Level of detail). Method 1000C, at 1050a, may include, using the selected video codec, decoding and extracting video using a first codec from bitstream 1042. Method 1000C, at 1052a, if image packing is signaled by metadata as determined by 1042, may include image unpacking. Image unpacking 1052a may include 2D to 1D scanning and 1D to 3D scanning as described herein. Method 1000C, at 1054a, may include extracting attribute values from the unpacked image. Extracted attribute values may be passed to reconstruction 1060. Method 1000C, at 1056a, may include codebook, indices, or transform coefficients AC decoding. Method 1000C, at 1058a, may include residual decoding. Results generated by 1050a, 1052a, 1054a, 1056a and 1058a may be passed to reconstruction 1060.

Method 1000C, at 1048b, may include a decision mechanism to select a video codec for decoding and at what level (e.g., Level of detail). Method 1000C, at 1050b, may include, using the selected video codec, decoding and extracting video using a first codec from bitstream 1042. Method 1000C, at 1052b, if image packing is signaled by metadata as determined by 1042, may include image unpacking. Image unpacking 1052b may include 2D to 1D scanning and 1D to 3D scanning as described herein. Method 1000C, at 1054b, may include extracting attribute values from the unpacked image. Extracted attribute values may be passed to reconstruction 1060. Method 1000C, at 1056b, may include codebook, indices, or transform coefficients AC decoding. Method 1000C, at 1058b, may include residual decoding. Results generated by 1050b, 1052b, 1054b, 1056b and 1058b may be passed to reconstruction 1060. This process may be repeated until all attribute values have been decoded from bitstream 1042.

Method 1000C may include, at 1060, reconstructing rendering primitives to generate primitives model 1062.

In some embodiments, the decoder decodes video substreams containing attribute data and optionally, decodes codebooks, codeword indices and residuals substreams, or transform coefficients for attributes if present. In case of frame packing being signaled in the metadata, the decoder may apply unpacking as signalled by the metadata, which includes 2D to 1D scanning and 1D to 3D scanning.

In some embodiments, the type of rendering primitive may be encoded in a bitstream. The rendering primitive type may be signaled via the bitstream as metadata. Table A details the primitive types.

TABLE A

| primitive_type Index | Primitive type |
|---|---|
| 0 | 3D Gaussian Splat |
| 1 | 2D Gaussian Splat |
| 2 | Ellipsoids |
| 3 | Spheres |
| 4 | Billboards/Planes |
| 5 | Convex shapes |
| 6 | Generalized Gaussians |
| 7 . . . 15 | RESERVED |

Table B lists attribute types for rendering primitives that may be encoded in a bitstream. The attribute types may be signaled via the bitstream as metadata.

TABLE B

| Attribute | | |
|---|---|---|
| types index | Identifier | Attribute type |
| 0 | ATTR_POSITION | Position |
| 1 | ATTR_ROTATION | Rotation |
| 2 | ATTR_SCALE | Scale |
| 3 | ATTR_BOX | Box |
| 4 | ATTR_RADIUS | Radius |
| 5 | ATTR_COLOR | Color |
| 6 | ATTR_OPACITY | Opacity |
| 7 | ATTR_SPHERICAL_HARMONICS_BAND_1 | Spherical Harmonics Band 1 |
| 8 | ATTR_SPHERICAL_HARMONICS_BAND_2 | Spherical Harmonics Band 2 |
| 9 | ATTR_SPHERICAL_HARMONICS_BAND_3 | Spherical Harmonics Band 3 |
| 10 | ATTR_GROUP_TAG | Group tag |
| 11 . . . 14 | ATTR_RESERVED | Reserved |
| 15 | ATTR_UNSPECIFIED | Unspecified |

In some embodiments, metadata signaled in the bitstream may include a group tag. The group tag enables coding tags for groups or objects along an octree that may be used for positional coding. Example codec mapping is listed in Table C. NONE codec type allows for RAW encoding use cases. GEOMETRY_CODEC includes instances such as G-PCC, PCL, and other tree or octree-based approaches. VIDEO_CODEC includes codecs such as H.265/HEVC, H.266/VVC, AV1 etc. AC_CODEC type refers to codecs using arithmetic coding to code a codebook for vector quantization and dimensionality reduction such as k-NN as well as their residuals, optionally.

TABLE C

| Codec_type_index | Codec type |
|---|---|
| 0 | NONE |
| 1 | GEOMETRY_CODEC |
| 2 | VIDEO_CODEC |
| 3 | AC_CODEC |
| 4 . . . 7 | RESERVED |

In some embodiments, metadata signaled in the bitstream may include scanning approaches. Example scanning approaches are listed in Table D.

TABLE D

| Scanning_method_index | Scanning method |
|---|---|
| 0 | 2D to 1D MORTON |
| 1 | 2D to 1D HILBERT |
| 2 | 2D to 3D MORTON |
| 3 | 2D to 3D HILBERT |
| 4 | 1D to 3D MORTON |
| 5 | 1D to 3D HILBERT |
| 6 . . . 15 | RESERVED |

The signaling of scanning approaches may include the following options:

The signaling may include the following options:
2D to 1D scanning:
   2D to 1D MORTON indicates that the scanning of frame pixels follows a Morton order.
   2D to 1D HILBERT indicates that the scanning of frame pixels follows a Hilbert order.
2D to 3D direct scanning:
   2D to 3D MORTON indicates that the scanning of frame pixels follows a Morton order.
   2D to 3D HILBERT indicates that the scanning of frame pixels follows a Hilbert order.
1D to 3D scanning (when 2D to 1D scanning is used):
   1D to 3D MORTON indicates that the mapping of 1D indices to 3D follows a Morton order.
   1D to 3D HILBERT indicates that the mapping of 1D indices to 3D follows a Hilbert order.

In some embodiments, metadata signaled in the bitstream may include frame packing metadata. Example frame packing metadata is provided in Table E.

TABLE E

| | |
|---|---|
| frame_packing( att_idx ) { | |
| group_tag_enabled_flag | u(1) |
| scanning_method_index | u(4) |
| if(scanning_method_index<2) | |
| secondary_scanning_method_index | u(4) |
| packing_block_size_width_minus1 | u(3) |
| packing_block_size_height_minus1 | u(3) |
| partition_block_size_width_minus1 | ue(v) |
| partition_cols_width_minus1 [att_idx] | ue(v) |
| partition_rows_height_minus1 [att_idx] | ue(v) |
| if(group_tag_enabled_flag) { | |
| tag_count_minus1 | ue(v) |
| for(tag_idx=0; tag_idx < tag_count_minus1 + 1; | |
| tag_idx ++) { | |
| map_col_idx[tag_idx] | ue(v) |
| map_row_idx[tag_idx] | ue(v) |
| } | |
| } | |

### Key Definitions

group_tag_enabled_flag indicates when set to 1 that tags are available and image tiles are mapped to tag indices, when set to 0 that tags are not enabled for frame packing.

scanning_method_index indicates the scanning method index according to Table D. This scanning could be set differently per attribute in an extended version of these exemplary signaling embodiments

secondary_scanning_method_index indicates when scanning_method_index is smaller than 2, what secondary scanning method is used to map 1D samples to 3D samples.

packing_block_size_width_minus1 plus 1 indicates the width of a packing block per primitive.

packing_block_size_height_minus1 plus 1 indicates the height of a packing block per primitive.

partition_block_size_width_minus1 plus 1 indicates the width of a partition block of tiles, typically square and corresponding to a Coding Unit, for example 63 for a 64×64 CU size.

partition_cols_width_minus1 [att_idx] plus 1 indicates the width in number of columns of the packed frame.

partition_rows_height_minus1 [att_idx] plus 1 indicates the height in number of rows of the packed frame.

tag_count_minus1 plus 1 indicates the number of tags present in the packed frame.

map_col_idx[tag_idx] indicates for tag index tag_idx the partition column index in the packed frame

map_row_idx[tag_idx] indicates for tag index tag_idx the partition row index in the packed frame.

TABLE F

| | |
|---|---|
| sequence_parameter_set( ) { | |
| primitive_type_index | u(4) |
| attribute_count_minus1 | ue(v) |
| for(att_idx=0; att_idx < attribute_count_minus1 + 1; | |
| att_idx++){ | |
| attribute_type_index[att_idx] | u(4) |
| codec_type_index[att_idx] | u(3) |
| If(codec_type_index == VIDEO_CODEC) { | |
| frame_packing(att_idx) | |
| } | |

### Key Definitions

Primitive_type_index is detailed in Table A

Attribute_count_minus1, plus 1 indicates the number of attributes.

Attribute_type_index[att_idx] indicates the attribute type of attribute with index att_idx, as specified in Table B

Codec_type_index[att_idx] indicates the codex type as listed in Table C for attribute with index equal to att_idx.

Frame_packing(att_idx) is provided in Table E.

In accordance with one aspect, an apparatus is provided comprising: at least one processor; and at least one memory storing instructions that, when executed with the at least one processor, cause the apparatus to perform: a processor and a memory storing instructions that, when executed with the processor, cause the apparatus to perform: (i) receiving an input model, the input model comprising a plurality of rendering primitives, (ii) selecting a first codec and a second codec for encoding one or more attributes associated with the plurality of rendering primitives; (iii) encoding, using the first codec, at least one first attribute of at least one of the plurality of rendering primitives, (iv) encoding, using the second codec, at least one second attribute of the at least one of the plurality of rendering primitives, and (v) forming at least one bitstream comprising the at least one first attribute and the at least one second attribute of the at least one of the plurality of rendering primitives.

In accordance with the example embodiment, the first codec is an octree-based codec.

In accordance with the example embodiment, the first attribute is primitive positional data of at least one of the plurality of rendering primitives.

In accordance with the example embodiment, the second codec is a video codec.

In accordance with the example embodiment, the second attribute is color, transparency, scale, rotation, spherical harmonics, or reflectance of the at least one of the plurality of rendering primitives.

In accordance with the example embodiment, the at least one memory and the computer program code are configured to, with the at least one processor, further cause the apparatus at least to perform aggregating metadata generated by the first codec and the second codec, wherein the at least one bitstream is formed further to comprise the aggregated metadata.

In accordance with the example embodiment, the at least one memory and the computer program code are configured to, with the at least one processor, further cause the apparatus at least to perform: selecting a third codec for encoding one or more attributes associated with the plurality of rendering primitives and encoding, using a third codec, at least one third attribute of the at least one of the plurality of rendering primitives, wherein the third codec is different from the first and second codec, wherein the at least one bitstream is formed further to comprise the at least one third attribute.

In accordance with the example embodiment, the first codec, the second codec, and the third codec are selected based at least in part on one or more characteristics of the input model.

In accordance with the example embodiment, the encoding of the at least one second attribute includes transforming the at least one second attribute into an image frame based on packing metadata generated by a 3D to 1D scan of the at least one first attribute.

In accordance with the example embodiment, the at least one first attribute is positional attribute data of the at least one of the plurality of rendering primitives.

In accordance with the example embodiment, the encoding of the at least one second attribute includes generating a codebook based on vector quantization of the at least one second attribute, wherein the at least one bitstream is formed further to comprise the codebook, wherein the codebook provides an index between the image frame and the at least one second attribute.

In accordance with the example embodiment, the encoding of the at least one second attribute includes generating a codebook based on dimensionality reduction of the at least one second attribute, wherein the at least one bitstream is formed further to comprise the codebook, wherein the codebook provides an index between the image frame and the at least one second attribute.

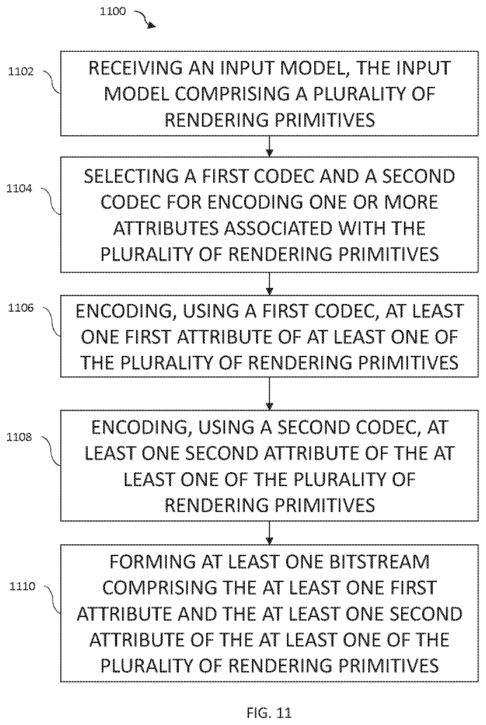

FIG. 11 illustrates an example method 1100 of hybrid decoding attributes of rendering primitives. Method 1100 may be implemented by encoder 130 where encoder 130 is an instance of user equipment 102 (all shown in FIG. 1). While FIG. 11 will be discussed in the context of FIG. 1, this is for clarity of explanation purposes only and the method described in FIG. 11 should not be considered limited by the components illustrated in FIG. 1. Method 1100 may be implemented by a processor, such as processor 106 of FIG. 1. Method 1100, at 1102, may include processor 106 receiving an input model, the input model comprising a plurality of rendering primitives. Method 1100, at 1104, may include processor 106 selecting a first codec and a second codec for encoding one or more attributes associated with the plurality of rendering primitives. Method 1100, at 1106, may include processor 106 encoding, using the first codec, at least one first attribute of at least one of the plurality of rendering primitives. Method 1100, at 1108, may include processor 106 encoding, using the second codec, at least one second attribute of the at least one of the plurality of rendering primitives. Method 1100, at 1110, may include processor 106 forming at least one bitstream comprising the at least one first attribute and the at least one second attribute of the at least one of the plurality of rendering primitives.

In accordance with another aspect, an apparatus is provided comprising: at least one processor; and at least one memory storing instructions that, when executed with the at least one processor, cause the apparatus to perform: a processor and a memory storing instructions that, when executed with the processor, cause the apparatus to perform: (i) receiving at least one bitstream, the at least one bitstream comprising a plurality of rendering primitives and metadata associated with the plurality of rendering primitives, (ii) decoding, using a first codec, at least one first attribute of at least one of the plurality of rendering primitives based at least in part on the metadata associated with the plurality of rendering primitives, (iii) decoding, using a second codec, at least one second attribute of the at least one of the plurality of rendering primitives based at least in part on the metadata associated with the plurality of rendering primitives, and (iv) determining an output of the at least one of the plurality of rendering primitives based at least in part on the at least one first attribute and the at least one second attribute.

In accordance with the example embodiment, the first codec is an octree-based codec used to decode positional data of the at least one of the plurality of rendering primitives.

In accordance with the example embodiment, the second codec is a video codec used to decode and extract attribute data of the at least one of the plurality of rendering primitives.

In accordance with the example embodiment, the attribute data includes at least one of color, transparency, scale, rotation, spherical harmonics, and reflectance.

In accordance with the example embodiment, the second attribute is color, transparency, scale, rotation, spherical harmonics, or reflectance of the at least one of the plurality of rendering primitives.

In accordance with the example embodiment, the at least one memory and the computer program code are configured to, with the at least one processor, further cause the apparatus at least to perform: extracting the metadata from the at least one bitstream to select the first codec and the second codec.

In accordance with the example embodiment, the at least one memory and the computer program code are configured to, with the at least one processor, further cause the apparatus at least to perform: decoding, using a third codec, at least one third attribute of the at least one of the plurality of rendering primitives, wherein the third codec is different from the first and second codec.

In accordance with the example embodiment, the first codec, the second codec, and the third codec are selected based at least in part on the metadata.

In accordance with the example embodiment, the decoding of the at least one second attribute includes transforming the at least one second attribute into an image frame based on packing metadata generated by a 3D to 1D scan of the at least one first attribute.

In accordance with the example embodiment, the decoding of the at least one second attribute includes extracting a codebook based on vector quantization of the at least one second attribute from the at least one bitstream, wherein the codebook provides an index between the image frame and the at least one second attribute.

In accordance with the example embodiment, the decoding of the at least one second attribute includes extracting a codebook based on dimensionality reduction of the at least one second attribute, wherein the codebook provides an index between the image frame and the at least one second attribute.

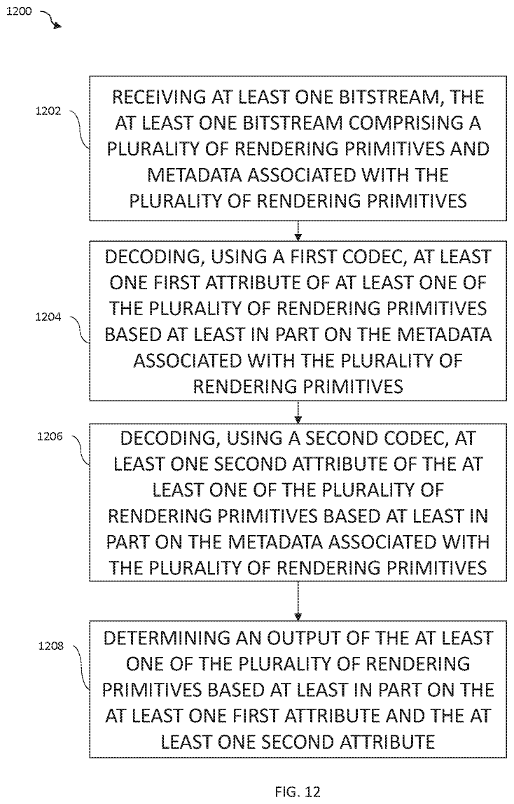

FIG. 12 illustrates an example method 1200 of hybrid decoding of attributes of rendering primitives. Method 1200 may be implemented by decoder 140 where decoder 140 is an instance of user equipment 102 (all shown in FIG. 1). While FIG. 12 will be discussed in the context of FIG. 1, this is for clarity of explanation purposes only and the method described in FIG. 12 should not be considered limited by the components illustrated in FIG. 1. Method 1200 may be implemented by a processor, such as processor 106 of FIG. 1. Method 1200, at 1202, may include processor 106 receiving at least one bitstream, the at least one bitstream comprising a plurality of rendering primitives and metadata associated with the plurality of rendering primitives. Method 1200, at 1204, may include processor 106 decoding, using a first codec, at least one first attribute of at least one of the plurality of rendering primitives based at least in part on the metadata associated with the plurality of rendering primitives. Method 1200, at 1206, may include processor 106 decoding, using a second codec, at least one second attribute of the at least one of the plurality of rendering primitives based at least in part on the metadata associated with the plurality of rendering primitives. Method 1200, at 1208, may include processor 106 determining an output of the at least one of the plurality of rendering primitives based at least in part on the at least one first attribute and the at least one second attribute.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising: at least one processor; and at least one memory storing instructions that, when executed by the at least one processor, cause the apparatus to perform at least the following: receiving an input model, the input model comprising a plurality of rendering primitives; selecting a first codec and a second codec for encoding one or more attributes associated with the plurality of rendering primitives; encoding, using the first codec, at least one first attribute of at least one of the plurality of rendering primitives; encoding, using the second codec, at least one second attribute of the at least one of the plurality of rendering primitives; and forming at least one bitstream comprising the at least one first attribute and the at least one second attribute of the at least one of the plurality of rendering primitives.

2. The apparatus of claim 1, wherein the first codec is an octree-based codec.

3. The apparatus of claim 1, wherein the at least one first attribute is primitive positional data of at least one of the plurality of rendering primitives.

4. The apparatus of claim 1, wherein the second codec is a video codec.

5. The apparatus of claim 3, wherein the at least second attribute is color, transparency, scale, rotation, spherical harmonics, or reflectance of the at least one of the plurality of rendering primitives.

6. The apparatus of claim 3, further being caused to perform: aggregating metadata generated by the first codec and the second codec, wherein the at least one bitstream is formed further to comprise the aggregated metadata.

7. The apparatus of claim 1, further being caused to perform: selecting a third codec for encoding one or more attributes associated with the plurality of rendering primitives; encoding, using a third codec, at least one third attribute of the at least one of the plurality of rendering primitives, wherein the third codec is different from the first and second codec, wherein the at least one bitstream is formed further to comprise the at least one third attribute.

8. An apparatus comprising: at least one processor; and at least one memory storing instructions that, when executed by the at least one processor, cause the apparatus to perform at least the following: receiving at least one bitstream, the at least one bitstream comprising a plurality of rendering primitives and metadata associated with the plurality of rendering primitives; decoding, using a first codec, at least one first attribute of at least one of the plurality of rendering primitives based at least in part on the metadata associated with the plurality of rendering primitives; decoding, using a second codec, at least one second attribute of the at least one of the plurality of rendering primitives based at least in part on the metadata associated with the plurality of rendering primitives; and determining an output of the at least one of the plurality of rendering primitives based at least in part on the at least one first attribute and the at least one second attribute.

9. The apparatus of claim 8, wherein the first codec is an octree-based codec used to decode positional data of the at least one of the plurality of rendering primitives.

10. The apparatus of claim 8, wherein the second codec is a video codec used to decode and extract attribute data of the at least one of the plurality of rendering primitives.

11. The apparatus of claim 10, wherein the attribute data includes at least one of color, transparency, scale, rotation, spherical harmonics, and reflectance.

12. The apparatus of claim 10, wherein the second attribute is color, transparency, scale, rotation, spherical harmonics, or reflectance of the at least one of the plurality of rendering primitives.

13. The apparatus of claim 10, further being caused to perform: extracting the metadata from the at least one bitstream to select the first codec and the second codec.

14. The apparatus of claim 8, further being caused to perform: decoding, using a third codec, at least one third attribute of the at least one of the plurality of rendering primitives, wherein the third codec is different from the first and second codec.

15. The apparatus of claim 14, wherein the first codec, the second codec, and the third codec are selected based at least in part on the metadata.

16. The apparatus of claim 8, wherein the decoding of the at least one second attribute includes transforming the at least one second attribute into an image frame based on packing metadata generated by a 3D to 1D scan of the at least one first attribute.

17. The apparatus of claim 8, wherein the decoding of the at least one second attribute includes extracting a codebook based on vector quantization of the at least one second attribute from the at least one bitstream, wherein the codebook provides an index between the image frame and the at least one second attribute.

18. A method comprising: receiving at least one bitstream, the at least one bitstream comprising a plurality of rendering primitives and metadata associated with the plurality of rendering primitives; decoding, using a first codec, at least one first attribute of at least one of the plurality of rendering primitives based at least in part on the metadata associated with the plurality of rendering primitives; decoding, using a second codec, at least one second attribute of the at least one of the plurality of rendering primitives based at least in part on the metadata associated with the plurality of rendering primitives; and determining an output of the at least one of the plurality of rendering primitives based at least in part on the at least one first attribute and the at least one second attribute.

19. The method of claim 18, wherein the first codec is an octree-based codec used to decode positional data of the at least one of the plurality of rendering primitives.

20. The method of claim 18, wherein the second codec is a video codec used to decode and extract attribute data of the at least one of the plurality of rendering primitives.
